(19) United States
(12) Patent Application Publication
(10) Pub. No.: US 2023/0217309 A1
(43) Pub. Date: Jul. 6, 2023

(54) COMMUNICATION DEVICE AND COMMUNICATION METHOD

(71) Applicant: NTT DOCOMO, INC., Tokyo (JP)

(72) Inventors: Syouichi Higuchi, Chiyoda-ku,Tokyo (JP); Daiki Takeda, Chiyoda-ku,Tokyo (JP); Masashi Anzawa, Chiyoda-ku,Tokyo (JP); Hiroki lshizuka, Chiyoda-ku,Tokyo (JP)

(73) Assignee: NTT DOCOMO, INC., Tokyo (JP)

(21) Appl. No.: 17/998,878

(22) PCT Filed: May 24, 2021
(86) PCT No.: PCT/JP2021/019612

§ 371 Date: Nov. 15, 2022

(30) Foreign Application Priority Data
May 26, 2020 (JP) 2020-091752

(51) Int. Cl. H04W 28/10; H04W 28/16

(52) U.S. Cl. CPC H04W 28/10; H04W 28/16

(57) ABSTRACT

A terminal is provided. The terminal includes a communication unit configured to perform communication, and a control unit configured to request a service with priority control related to the communication. The control unit is: an application that performs configuration related to a resource control unit for distributing communication packets associated with a communication path; or a client of the service with priority control related to the communication.

### FIELD OF THE INVENTION

The present invention relates to a communication device and a communication method in a wireless communication system.

### BACKGROUND OF THE INVENTION

In 3GPP (3rd Generation Partnership Project), in order to achieve further larger system capacity, further faster data transmission speed, further lower latency in a wireless communication section, etc., a wireless communication method called 5G or NR (New Radio) has been discussed (hereinafter, the wireless communication method is referred to as “5G” or “NR”). In 5G, various wireless technologies have been discussed in order to meet requirements including latency equal to or less than 1 ms in a wireless communication section while realizing a throughput equal to or greater than 10 Gbps.

In NR, an architecture has been discussed which includes: 5GC (5G Core Network) corresponding to EPC (Evolved Packet Core) that is a core network in an LTE (Long Term Evolution) network architecture; and NG-RAN (Next Generation-Radio Access Network) corresponding to E-UTRAN (Evolved Universal Terrestrial Radio Access Network) that is a RAN (Radio Access Network) in the LTE network architecture (e.g., non-patent document 1).

### CITATION LIST

### Non-Patent Document

[Non-Patent Document 1] 3GPP TS 23.501 V16.3.0 (2019-12)

### SUMMARY OF THE INVENTION

### Technical Problem

In Naas (Network as a Service) in a wireless network, for example, a service is provided in which network quality selected by a user from multiple options is provided on demand. As a method of providing the network quality to the user, multiple virtual communication paths (queues) are assumed to be provided to a terminal. However, controlling the queues of communication paths by a NaaS client such as an application has not been discussed.

The present invention has been made in view of the above point, and an object of the present invention is controlling QoS (Quality of Service)-provided communications by a NaaS (Network as a Service) client.

### Solution to Problem

According to the disclosed technique, a terminal is provided. The terminal includes a communication unit configured to perform communications, and a control unit configured to request a service with priority control related to the communications. The control unit is: an application that performs configuration related to a resource control unit for distributing a communication packet associated with a communication path; or a client of the service with priority control related to the communications.

### Advantageous Effects of Invention

According to the disclosed technique, the NaaS (Network as a Service) client can control QoS (Quality of Service)-provided communications.

### BRIEF DESCRIPTION OF THE DRAWINGS

FIG. 1 is a drawing illustrating a wireless network according to an embodiment of the present invention.

FIG. 2 is a drawing illustrating a core network according to an embodiment of the present invention.

FIG. 3 is a drawing illustrating an example of priority control according to an embodiment of the present invention.

FIG. 4 is a diagram illustrating an example (1) of a communication path according to an embodiment of the present invention.

FIG. 5 is a diagram illustrating an example (2) of a communication path according to an embodiment of the present invention.

FIG. 6 is a diagram illustrating an example (3) of communication paths according to an embodiment of the present invention.

FIG. 7 is a diagram illustrating an example (4) of communication paths according to an embodiment of the present invention.

FIG. 8 is a diagram illustrating an example (5) of communication paths according to an embodiment of the present invention.

FIG. 9 is a diagram illustrating an example (6) of a communication path according to an embodiment of the present invention.

FIG. 10 is a flowchart illustrating an example (1) of communication in which NaaS is configured according to an embodiment of the present invention.

FIG. 11 is a flowchart illustrating an example (2) of communication in which NaaS is configured according to an embodiment of the present invention.

FIG. 12 is a flowchart illustrating an example (3) of communication in which NaaS is configured according to an embodiment of the present invention.

FIG. 13 is drawing illustrating an example of a functional structure of a network node 10 according to an embodiment of the present invention.

FIG. 14 is drawing illustrating an example of a functional structure of a terminal 20 according to an embodiment of the present invention.

FIG. 15 is a drawing illustrating an example of a hardware structure of the network node 10 or the terminal 20 according to an embodiment of the present invention.

### DETAILED DESCRIPTION OF THE PREFERRED EMBODIMENTS

In the following, referring to the drawings, one or more embodiments of the present invention will be described. It should be noted that the embodiments described below are examples. Embodiments of the present invention are not limited to the following embodiments.

In operations of a wireless communication system according to an embodiment of the present invention, conventional techniques will be used appropriately. With respect to the above, for example, the conventional techniques are related to, but not limited to, the existing LTE. Further, it is assumed that the term “LTE” used in the present specification has, unless otherwise specifically mentioned, a broad meaning including a scheme of LTE-Advanced and a scheme after LTE-Advanced (e.g., NR), or wireless LAN (Local Area Network).

Further, in an embodiment of the present invention, the expression, radio parameters are “configured” may mean that a predetermined value is pre-configured, or may mean that a radio parameter indicated by a network node 10 or a terminal 20 is configured.

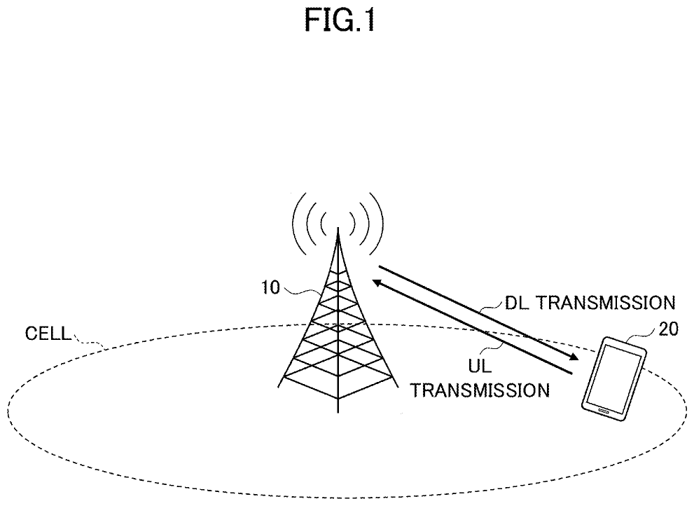

FIG. 1 is a drawing illustrating a wireless network according to an embodiment of the present invention. As illustrated in FIG. 1, a system including the wireless network according to an embodiment of the present invention includes a base station 10 and a terminal 20. In FIG. 1, a single base station 10 and a single terminal 20 are illustrated as an example. There may be a plurality of base stations 10 and a plurality of terminals 20. The base station 10 may be referred to as a network node 10.

The base station 10 is a communication apparatus that provides one or more cells and performs wireless communications with the terminal 20. Physical resources of the radio signal may be defined in the time domain and the frequency domain, the time domain may be defined by the number of OFDM symbols, and the frequency domain may be defined by the number of sub-carriers or resource blocks. The base station 10 transmits a synchronization signal and system information to the terminal 20. The synchronization signal is, for example, NR-PSS (Primary Synchronization Signal) and NR-SSS (Secondary Synchronization Signal). The system information is transmitted via, for example, NR-PBCH (Physical Broadcast Channel), and may be referred to as broadcast information. As shown in FIG. 1, the base station 10 transmits a control signal or data in DL (Downlink) to the terminal 20 and receives a control signal or data in UL (Uplink) from the terminal 20. The base station 10 and terminal 20 are capable of transmitting and receiving a signal by performing the beamforming. Further, the base station 10 and the terminal 20 can both apply MIMO (Multiple Input Multiple Output) communication to DL or UL. Further, both the base station 10 and terminal 20 may perform communications via an SCell (Secondary Cell) and a PCell (Primary Cell) using CA (Carrier Aggregation).

The terminal 20 may be a communication apparatus that includes a wireless communication function such as a smartphone, a mobile phone, a tablet, a wearable terminal, a communication module for M2M (Machine-to-Machine), or the like. As shown in FIG. 1, the terminal 20 uses various communication services provided by the wireless communication system by receiving control signals or data in DL from the base station 10 and transmitting control signals or data in UL to the base station 10. In addition, the terminal 20 may have a function as a client application that communicates with an application server arranged in a network.

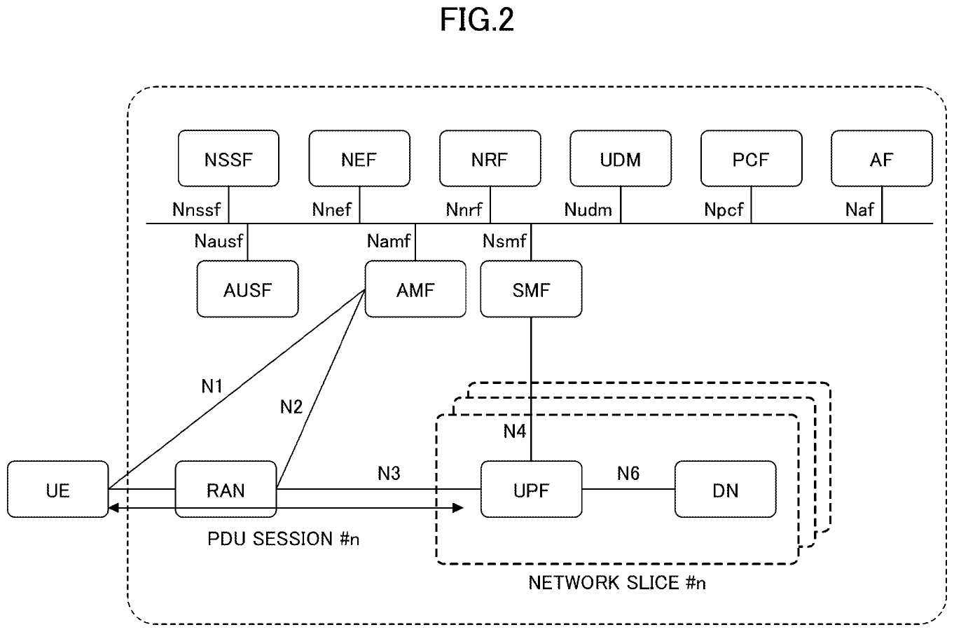

FIG. 2 is a drawing illustrating a core network in an embodiment of the present invention. As illustrated in FIG. 2, a system including a core network in an embodiment of the present invention consists of a UE, which is a terminal 20, and a plurality of network nodes 10. Hereafter, one network node 10 corresponds to each function, but multiple functions may be implemented by one network node 10 or one function may be implemented by multiple network nodes 10. The “connections” described below may be either a logical connection or a physical connection.

RAN (Radio Access Network) is a network node 10 with wireless access functions, and is connected to UE, AMF (Access and Mobility Management Function) and UPF (User plane function). The base station 10 may be a network node 10 corresponding to the RAN. The AMF is a network node 10 having functions of, for example, terminating the RAN interface, terminating the NAS (Non-Access Stratum), managing registration, managing connection, managing reachability, and managing mobility. The UPF is a network node 10 interconnected with DN (Data Network), and has functions such as a PDU (Protocol Data Unit) session point to an external unit, routing and forwarding packets, and QoS (Quality of Service) handling of the user plane. The UPF and the DN constitute a network slice. In a wireless communication network in an embodiment of the present invention, multiple network slices are included.

AMF is connected to UE, RAN, SMF (Session Management Function), NSSF (Network Slice Selection Function), NEF (Network Exposure Function), NRF (Network Repository Function), UDM (Unified Data Management), AUSF (Authentication Server Function), PCF (Policy Control Function), and AF (Application Function). AMF, SMF, NSSF, NEF, NRF, AUSF, PCF, and AF are network nodes 10 connected to each other via interfaces Namf, Nsmf, Nnssf, Nnef, Nnrf, Nudm, Nausf, Npcf, Naf based on the respective services.

The SMF is a network node 10 having functions such as session management, Internet Protocol (IP) address assignment and management of UE, DHCP (Dynamic Host Configuration Protocol) function, ARP (Address Resolution Protocol) proxy, and roaming function. The NEF is a network node 10 having a function of indicating capabilities and events to other NFs (Network Functions). The NSSF is a network node 10 having functions of, for example, selecting the network slice to which the UE is to be connected, determining the allowed NSSAI (Network Slice Selection Assistance Information), determining the configured NSSAI, and determining the AMF set to which the UE is to be connected. The PCF is a network node 10 having a function of performing policy control of the network. The AF is a network node 10 having a function of controlling an application server. The NRF is a network node 10 having a function of discovering NF instances which provide services.

Here, a service that provides a network called NaaS (Network as a Service) includes the concepts of 1)-4) below.

1) Network construction mainly for hardware deployment. A LAN (Local Area Network) including a network device such as a backbone router. For example, outsourcing of construction of a LAN in an office.
2) WAN (Wide Area Network) construction. A WAN including a virtualization technology such as a VPN. For example, a WAN construction enabling mutual access between branch offices and business offices.
3) Line services based on a specific network configuration or quality. Provision of IoT platforms. For example, IoT network installation by LoRAWAN (registered trademark) or the like, and an IoT solution for a corporation. In addition, for example, the service may be a service for providing a bandwidth-guaranteed line service to general users, and may include construction work.
4) A service that provides 3) above to general users on demand. This service is a service in which users select network quality from multiple options to provide a line with quality such as “X Mbps bandwidth guaranteed” and “within Y msec latency”.

Embodiments of the present invention relate to a technology for implementing the NaaS of 4) above in a wireless network. In NaaS in a wired network, in addition to a peak rate and a failure rate, items such as a form of bandwidth guarantee classified into QoS and a delay time are defined as SLA (Service Level Agreement).

Examples of quality items that can be provided by the SLA are, for example, the following items 1) to 9). In a line service with SLA, SLA is defined in advance, and actions to be taken in the event of a violation are clarified. For example, in a case where the average delay time exceeds Y msec, an agreement is made such that the fee is reduced by Z %.

1) Traffic related items (average throughput, delay time, packet loss rate, etc.)
2) Utilization rate/Availability
3) Failure indication
4) Number of simultaneous connections
5) Backup-related items (Frequency, items, storage period, etc.)
6) Log related items (Frequency, items, storage period, etc.)
7) Support desk and other contact systems
8) Failure related items (recovery time, response time, on-site response availability, etc.)
9) Types of quality levels listed above

There is no technology to support QoS guarantees for Layer 1-Layer 2 or other wireless link sections. On the other hand, there are functions that are optimized for the requirement of constantly sending small packets, such as voice calls. Table 1 shows examples of functions similar to QoS as EPC (Evolved Packet Core) functions assuming a voice call or the like in LTE.

TABLE 1

| | | | Delay | Loss | |
|---|---|---|---|---|---|
| QCI | Guarantee | Priority | Budget | rate | Application |
| 1 | GBR | 2 | 100 ms | 1e−2 | VoIP |
| 2 | GBR | 4 | 150 ms | 1e−3 | Video call |
| 3 | GBR | 5 | 300 ms | 1e−6 | Streaming |
| 4 | GBR | 3 | 50 ms | 1e−3 | Real-time |
| | | | | | game |
| 5 | Non-GBR | 1 | 100 ms | 1e−6 | IMS |
| | | | | | signaling |
| 6 | Non-GBR | 7 | 100 ms | 1e−3 | Interactive |
| | | | | | game |
| 7 | Non-GBR | 6 | 300 ms | 1e−6 | TCP |
| 8 | Non-GBR | 8 | 300 ms | 1e−6 | protocol |
| 9 | Non-GBR | 9 | 300 ms | 1e−6 | (browsing, |
| | | | | | email, file |
| | | | | | download) |

As illustrated in Table 1, a QCI (QoS Class Identifier) is associated with guarantee or non-guarantee of bit rates (Guarantee), priority, allowable delay (Delay Budget), packet loss rate (Loss rate), and applications. For example, if the QCI is 4, the bit rate is guaranteed (GBR: Guaranteed bit rate), the priority is 3, the allowable delay is 50 ms, the packet loss rate is ten to the minus three (10−3), and the application is a real-time game. The base station 10 performs scheduling or the like in accordance with the QCI, and communication is performed so as to satisfy the parameters shown in Table 1. However, QoS is not guaranteed in actual communication.

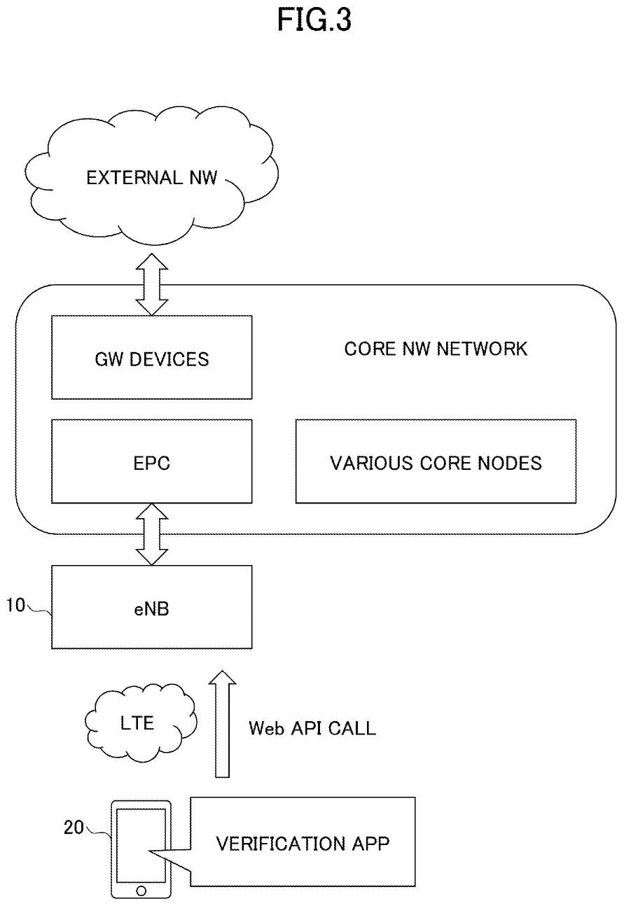

FIG. 3 is a drawing illustrating an example of priority control according to an embodiment of the present invention. Embodiments of the present invention contemplate NaaS that provides on-demand network quality to be selected by the user from a plurality of options. For example, network quality may be controlled as shown in FIG. 3. As shown in FIG. 3, the core network includes an EPC, various core nodes, GW devices, etc., and has communication channels with external networks and eNBs. It should be noted that in the embodiment of the present invention, priority control may be performed by any method, and the specific method of priority control is not limited.

For example, the terminal 20, as a NaaS client, may transmit a priority control request based on a specified interface to the base station 10 which is eNB via the LTE wireless network. As an example of priority and quality control implemented primarily by the base station 10, the desired network quality may be achieved by control via scheduling by the base station 10 and by changes of parameters by the base station 10. Also, as another example of priority and quality control implemented primarily by the core network, a MEC (Mobile Edge Computing) server may be located in the core network, or slicing control by the 5G core may be performed. Further, as an example of priority and quality control implemented primarily by the core network, the priority control function provided by the QCI control that is provided by the LTE may be implemented, or the control of the communication channel including the network and the terminal using the multiple PDNs or the like may be performed.

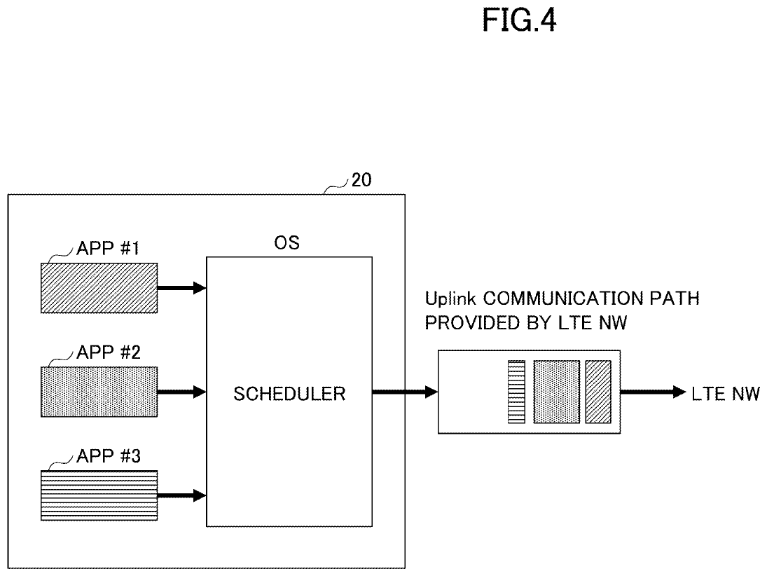

FIG. 4 is a diagram illustrating an example (1) of a communication path according to an embodiment of the present invention. In a conventional system configuration, basically a single communication path is provided. For example, as illustrated in FIG. 4, in a case where a terminal 20 uses a RAT (Radio access technology, e.g., LTE or 5G), a single communication path is provided. In other words, an uplink communication path provided by an LTE network is used by APP #1, APP #2, and APP #3. Note that, when data communication and voice communication are used, corresponding communication paths may be provided to the terminal 20. However, a single communication path is used in each of the communications.

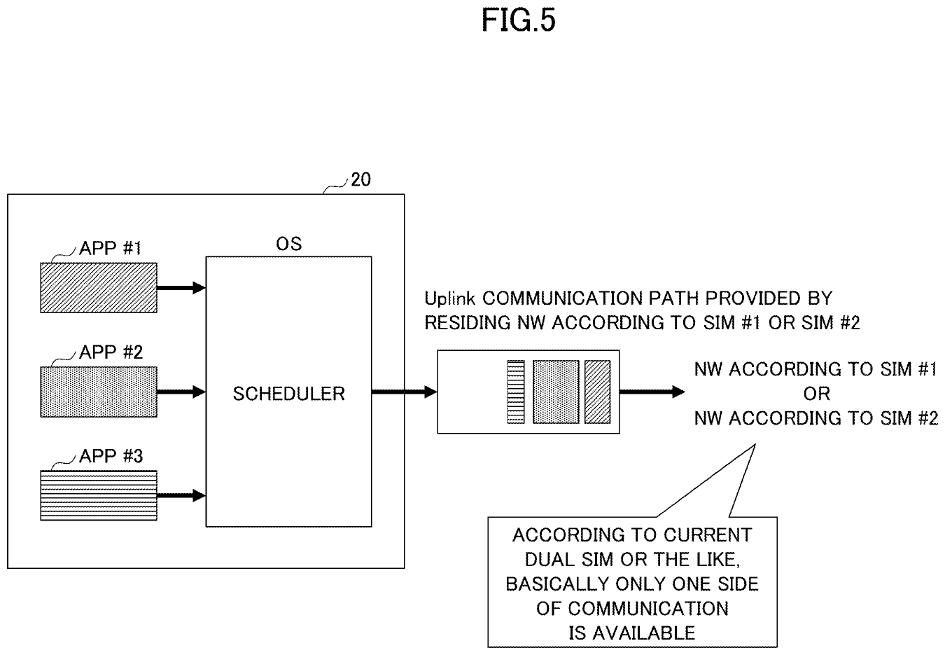

FIG. 5 is a diagram illustrating an example (2) of a communication path according to an embodiment of the present invention. As illustrated in FIG. 5, even in a case where the terminal 20 supports dual SIM (Subscriber Identity Module), basically, only one side of communication is available. SIM #1 and SIM #2 may be switched in the time domain, and an uplink communication path provided by a residing network at a certain time point, is used by APP #1, APP #2, and APP #3.

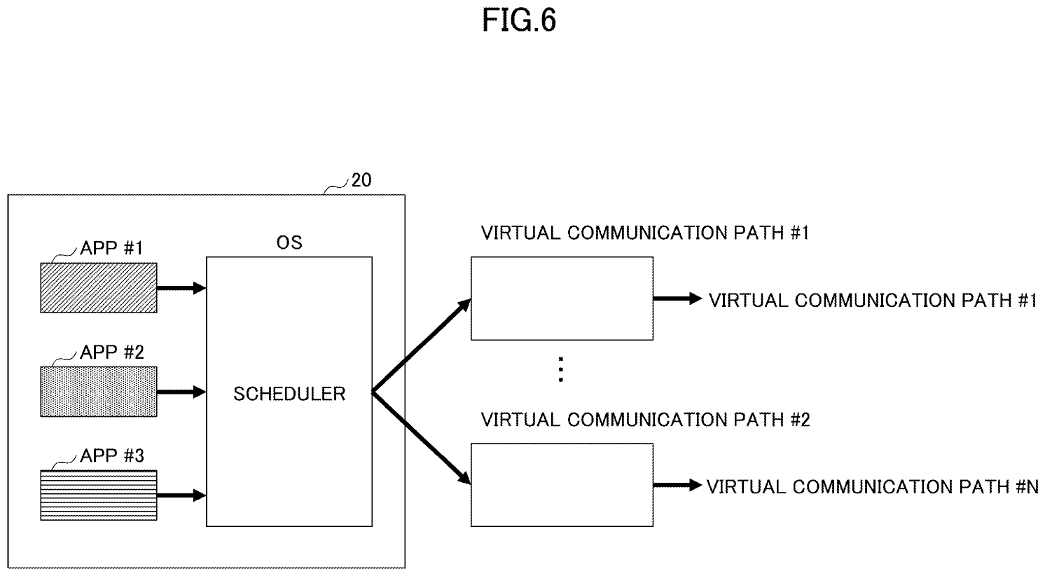

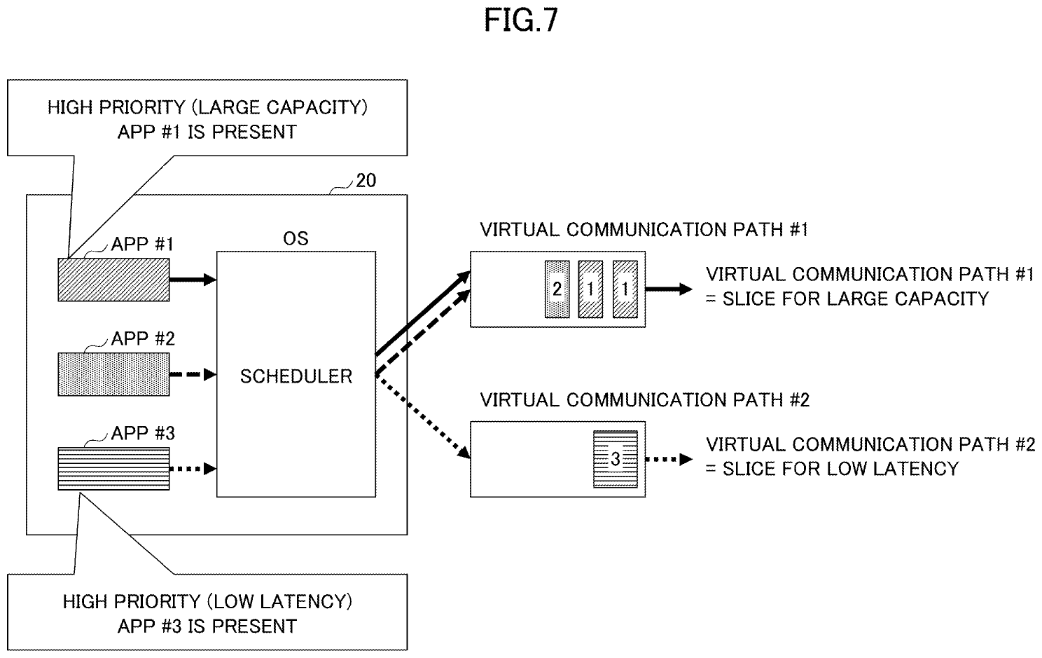

FIG. 6 is a diagram illustrating an example (3) of communication paths according to an embodiment of the present invention. For example, in the future, it is expected that multiple virtual communication paths (or may be queues) are provided to the terminal 20 depending on the service (e.g., application type or contract) as illustrated in FIG. 6. For example, the multiple communication paths may be provided by: network slicing by 5GC; multiple bearers; or path control on the core network side (e.g., MEC (Mobile Edge Computing)). Even in a case of a single network as a RAT, there exist multiple virtual communication paths. For example, FIG. 7 may be viewed as multiple APNs (Access point names) from the terminal 20.

FIG. 7 is a diagram illustrating an example (4) of communication paths according to an embodiment of the present invention. For example, in a case where two communication paths for large capacity or for low latency are provided by the network slicing to the terminal 20, the communication paths may be virtually switched by the network side. As illustrated in FIG. 7, the communication according to APP #1 that prioritizes large capacity, may use a virtual communication path #1 that is a slice for large capacity, and the communication according to APP #3 that prioritizes low latency, may use a virtual communication path #2 that is a slice for low latency. The virtual communication path may be a network slice by 5GC as described above, may be a bearer with a different priority (QCI), or may be another virtual communication path.

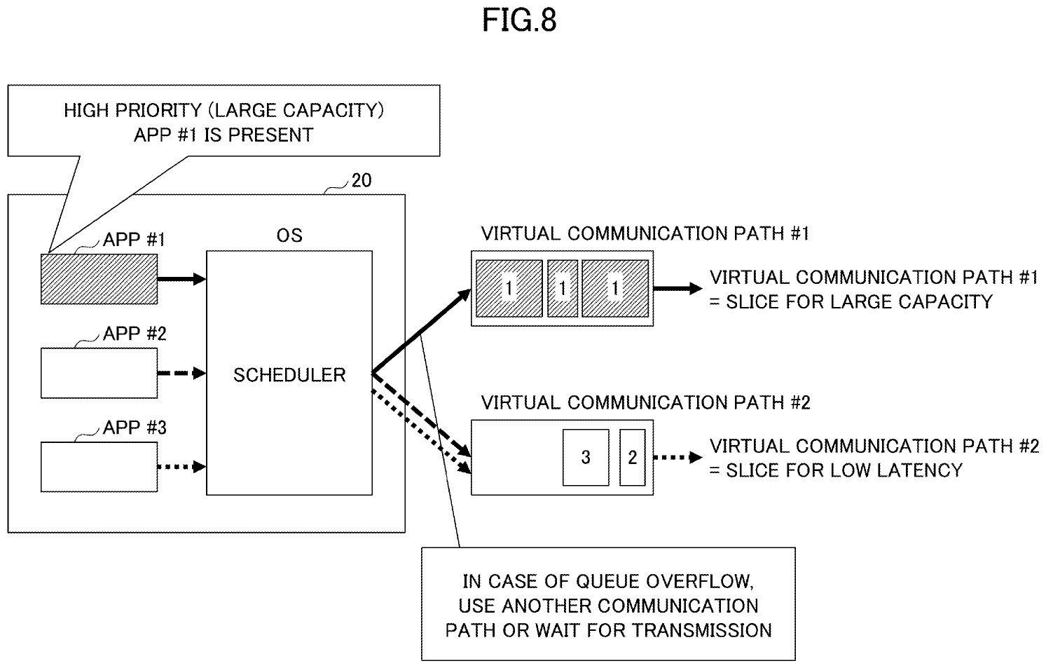

FIG. 8 is a diagram illustrating an example (5) of communication paths according to an embodiment of the present invention. As illustrated in FIG. 8, for example, when the amount of communication by APP #1 that prioritizes large capacity increases and the virtual communication path #1, that is, the queue of the slice for large capacity overflows, the communication by the APP #1 may use another communication path such as a communication path #2 or may wait for transmission.

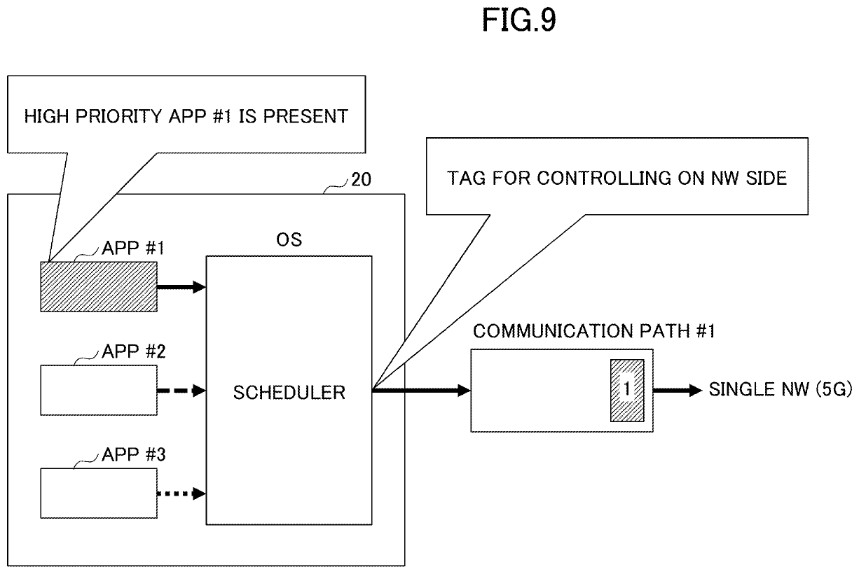

FIG. 9 is a diagram illustrating an example (6) of a communication path according to an embodiment of the present invention. Although a state in which a plurality of virtual communication paths are provided is mainly assumed, even in a case of a single communication path, a case in which the core network determines the communication path, based on a predetermined tag (for example, an IP address, an application type, or the like) assigned by APP can be included as an embodiment of the present invention. As illustrated in FIG. 9, APP #1 to which a high priority is configured assigns a tag for control on the network side to the communication. Even if the network has a single communication path #1 (for example, 5G), the core network can control the priority of the communication on the network side.

Priority control using a queue as a simple, flexible, and realistic priority control algorithm will be described below as an example. In an embodiment of the present invention, a specific method of priority control is not limited. The allocation of resources within the queue may be implemented in any manner. Note that, hereinafter, a “queue” is an example indicating an implementation method. For example, “a unit of resource control for a communication device to distribute communication packets to communication paths provided with different communication qualities” may be replaced with the “queue”. Note that, hereinafter, a “virtual communication path” is assumed to be a method in which a network provides virtually different communication qualities to the terminal 20. Further, the “virtual communication path” may include slicing by 5GC, bearer control or QoS control provided in 5G/LTE, and priority control by other network implementations.

The priority control that assumes a plurality of queues can be implemented by a conventional technique. For example, based on a simple priority value (for example, QCI), a communication path estimated to provide higher communication quality according to the priority value may be selected. In addition, for example, a priority (for example, an application type or the like) related to QCI or 5GC is defined as an already standardized function, and an operation of putting into the queue or associating with a bearer can be performed by an OS (Operating system) using the priority.

On the other hand, in the conventional technology, because the OS cannot determine details such as whether or not a communication request from an application is critical, and what kind of control is performed when the queue of the communication path overflows, it is assumed that the OS cannot perform efficient priority control assuming a plurality of paths. Therefore, enabling the application to perform configuration of the queue of the communication path is proposed.

For example, a client requesting NaaS-based communications, such as an application or a service, may be enabled to perform configuration related to the queue. The configuration related to the queue is, for example, a configuration related to priority control for the communication path. Note that, hereinafter, the application or service requesting NaaS-based communications, is simply referred to as APP. In addition, a scheduler or the like implemented in the OS or middleware that receives a packet transmission request from APP and transmits a packet to the communication path, is hereinafter referred to as an “OS” as an example.

The APP running on the terminal 20 may configure the configurations indicated by the queue configuration A, queue configuration B (a), and/or the queue configuration B (b), together with the requirement related to NaaS communication, such as delay characteristics (average value, minimum value, jitter, etc.), data rates (uplink/downlink, average value, minimum value, peak value, etc.), reliability (average value, minimum value, etc.), a number of simultaneous connections, etc.

Queue configuration a: configuration related to whether app can exclusively use the queue

For example, the configuration may be prohibiting the queue that is being used by the APP from receiving a packet that is requested to be transmitted by another APP. The configuration may be configurations indicated by an option 1) to an option 3) as shown below.

Option 1) Other APPs need not be allowed by the configuration

In other words, the APP may occupy the queue. A plurality of APPs need not be allowed by the configuration.

Option 2) Other APPs may be allowed by the configuration

For example, as an additional configuration to the above-described configuration, a number of APPs that can be allowed by the currently-used queue (may be a number of only NaaS-requesting APPs, or may be a total number including general APPs), and a total sum of communication capacities requested by multiple APPs, may be limited. A plurality of APPs may be allowed by the configuration.

Option 3) Other APPs may be allowed only in a case where there is enough room in the queue

If necessary, other APPs may be allowed based on a result of an estimation of congestion degrees of a network. Other APPs may be allowed only in a case where it is assumed that the queue can sufficiently process packets based on communication path situations in the past. For example, the APP may be input to the queue as the first priority, and other APPs may be allowed in a case where the OS determines or estimates that the APP will not be affected. In other words, multiple APPs may be allowed only in a case where there is enough room in the queue.

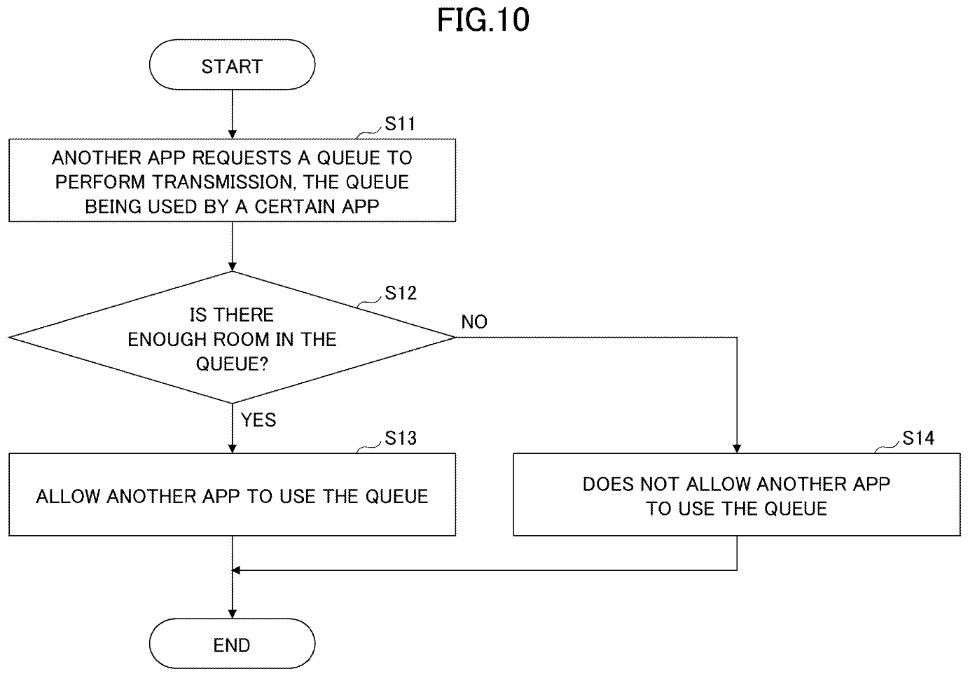

FIG. 10 is a flowchart illustrating an example (1) of communication in which NaaS is configured according to an embodiment of the present invention. In step S11, another APP requests a queue to perform transmission, the queue being used by a certain APP. Subsequently, the OS determines whether there is enough room in the queue (S12). In a case where there is enough room in the queue (YES in S12), the step proceeds to step S13, and, in a case where there is no enough room in the queue (NO in S12), the step proceeds to step S14. In step S13, the OS allows the another APP to use the queue. On the other hand, in step S14, OS does not allow the another APP to use the queue.

Queue configuration B (a): configuration related to an operation in a case where the OS determines that there is no queue that satisfies a request by an APP when requested

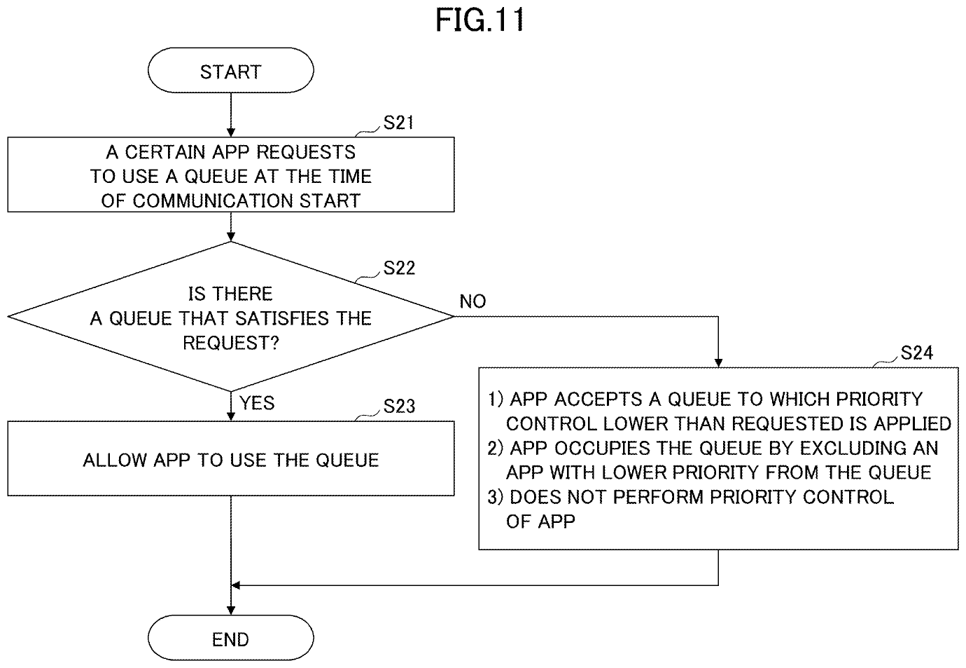

FIG. 11 is a flowchart illustrating an example (2) of communication in which NaaS is configured according to an embodiment of the present invention. In step S21, a certain APP requests for using the queue at the time of communication start. In step S22, the OS determines whether there is a queue that satisfies the request. In a case where there is a queue that satisfies the request (YES in S22), the step proceeds to step S23, and, in a case where there is no queue that satisfies the request (NO in S22), the step proceeds to step S23. In step S23, the OS allows the APP to use the queue. On the other hand, in step S24, operations indicated by the following option 1) to option 3) may be performed.

Option 1) Priority control lower than requested is accepted by the APP

The OS may indicate, to the APP, the communication quality that is provided by the assigned lower priority as a result. In addition, the APP may change the request based on the indication, or may stop priority control.

Option 2) Request to occupy the queue by excluding other APPs with lower priority from the queue

The queue may be a queue that becomes a queue that satisfies a request by the APP in a case where other APPs are excluded. Whether to exclude or allow other APPs, may be announced by the APP or may be determined by the OS. In addition, an APP may announce that the APP is to be excluded from the queue by other APPs.

Option 3) The OS or the network does not perform priority control of the APP

The OS or the network may indicate, to the APP, that the priority control is not performed.

Queue configuration B (b): configuration related to an operation in a case where the OS determines that there is no queue that satisfies a request

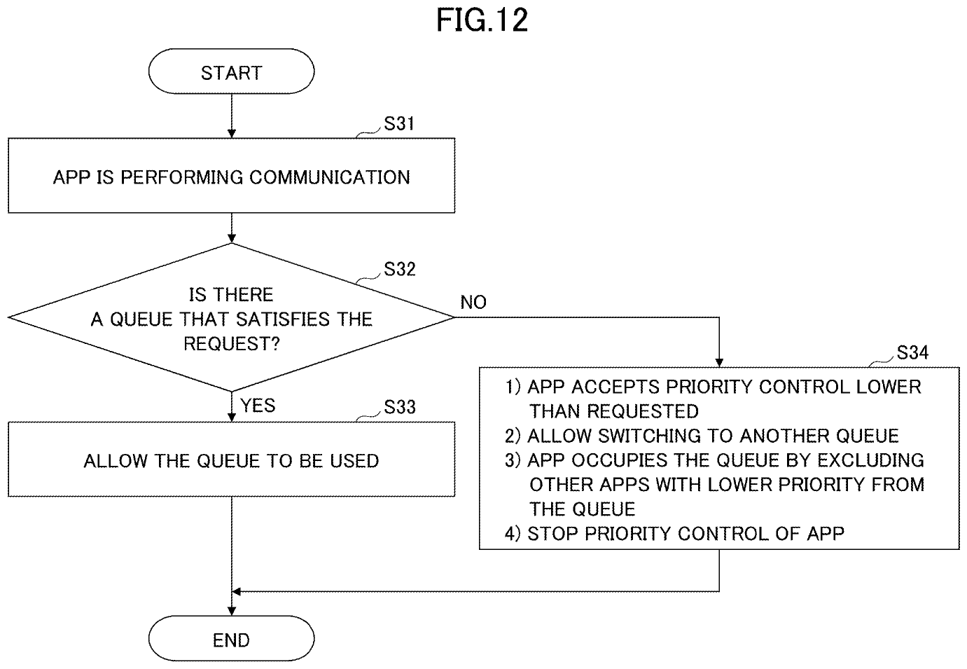

FIG. 12 is a flowchart illustrating an example (3) of communication in which NaaS is configured according to an embodiment of the present invention. In step S31, the APP is performing the communication. In step S32, the OS determines whether there is a queue that satisfies a request. In a case where there is a queue that satisfies the request (YES in S32), the step proceeds to step S33, and, in a case where there is no queue that satisfies the request (NO in S32), the step proceeds to step S34. In step S33, the OS allows the APP to use the queue. On the other hand, in step S34, operations indicated by the following option 1) to option 4) may be performed.

Option 1) Priority control lower than requested is accepted by the APP

In other words, priority control may be continued regardless of whether NaaS can be provided. In a case where NaaS cannot be provided, the OS may indicate, to the APP, that NaaS become unable to be provided. In addition, the APP may configure whether the indication is necessary.

Option 2) Switching to a different queue (e.g., from NR to LTE) is allowed

For example, even when possibility of communication interruption is expected, NaaS communication is continued by transitioning to another queue. In a case where there is possibility of communication interruption, the OS may indicate, to the APP, that there is possibility of communication interruption. In addition, the APP may configure whether the indication is necessary. Here, the OS may switch to a queue that is determined to be a queue in which there are only APPs with low communication requirement. The APPs with low communication requirement may be APPs that allow other APPs as shown in A: 2). The OS may determine the communication requirement, based on each option of A, B (a), or B (b).

Option 3) Request to occupy the queue by excluding other APPs with lower priority from the queue

The queue may be a queue that becomes a queue that satisfies a request by the APP in a case where other APPs are excluded. Whether to exclude or allow other APPs, may be announced by the APP or may be determined by the OS. In addition, an APP may announce that the APP is to be excluded from the queue by other APPs.

Option 4) The OS or a network to stop performing priority control of the APP

The OS or the network may indicate, to the APP, that the priority control is to be stopped.

Note that the OS may assume that respective options of the above-described queue configuration A, the queue configuration B (a) or the queue configuration B (b), are switched based on a given condition. For example, it may be assumed that the queue configuration A: option 1) that other APPs need not be allowed is applied to an APP having a delay requirement (or an APP presenting a numerical value of the severest delay requirement among APPs having a delay requirement) regardless of a request of the APP. Note that the given condition may be defined by at least one of requirements related to NaaS communication such as delay characteristics (average value, minimum value, jitter, and the like), data rates (uplink/downlink, average value, minimum value, peak value, and the like), reliability (average value, minimum value, and the like), and the number of simultaneous connections, etc.

As a premise of the configuration method of the queue of the communication path executed by the APP in an embodiment of the present invention, the user may select a specific configuration of the queue by the APP, or may change the configuration of the queue in real time. In addition, the APP provider may designate the configuration of the queue or may change the configuration of the queue in real time. In addition, the APP provider may designate the configuration of the queue according to a plurality of combinations, and the user may perform the configuration of the queue in the APP according to a contract situation with the APP provider or the operator.

The APP or NaaS client may indicate a combination of specific queue configuration options. Table 2 summarizes the queue configuration A, the queue configuration B (a), and the queue configuration B (b).

TABLE 2

| | | | Queue |
|---|---|---|---|
| | | Queue | configuration |
| | | configuration | B (b): when |
| | | B (a) : at the | APP is |
| | | time of | performing |
| | | request from | communication, |
| | | APP, how to | how to operate |
| | | operate in a | in a case |
| | Queue | case where it | where it is |
| | configuration | is determined | determined |
| | A: whether | that there is | that there is |
| | APP can | no queue that | no queue that |
| | exclusively | satisfies the | satisfies the |
| | use queue | request | request |
| Option | Does not | APP allows | APP allows |
| 1 | allow | priority | priority |
| | multiple APPs | control lower | control at |
| | | than the | priority lower |
| | | request | than the |
| | | | request |
| Option | Allow | Occupy the | Allow to be |
| 2 | multiple APPs | queue by | switched to |
| | | excluding | another queue |
| | | other APPs | |
| | | with lower | |
| | | priority from | |
| | | the queue | |
| Option | Allow | Does not | Occupy the |
| 3 | multiple APPs | perform | queue by |
| | only in a | priority | excluding |
| | case where | control of | other APPs |
| | there is | the APP | with lower |
| | enough room | | priority from |
| | in the queue | | the queue |
| Option | | | Stop priority |
| 4 | | | control of the |
| | | | APP |

In Table 2, all of the queue configuration A, queue configuration B (a), and queue configuration B (b) may be used. For example, an APP or NaaS client may configure the queue configuration A=option 1, the queue configuration B (a)=option 2, and the queue configuration B (b)=option 2. In addition, the APP or NaaS client may indicate a plurality of options together and may cause the OS or the network to select one of the options. For example, the APP or the NaaS client may configure the queue configuration A=option 1, the queue configuration B (a)=option 2, and the queue configuration B (b)=option 2 or option 3. Further, for example, the APP or the NaaS client may configure the queue as shown in Table 3.

TABLE 3

| | Queue | Queue |
|---|---|---|
| Queue | configuration | configuration |
| configuration A | B (a) | B (b) |
| Option 1 | Option 3 | Option 1 or |
| | | option 2 |

In the configuration shown in Table 3, a plurality of options are configured for the queue configuration B (b), and the OS or the network may select one of the options.

In order to realize efficient priority control assuming a plurality of paths, the conventional QCI table shown in Table 1 and the queue configuration shown in Table 3 may be combined. Specific examples are shown in Table 4.

TABLE 4

| | | | | | | Queue | Queue | Queue |
|---|---|---|---|---|---|---|---|---|
| | | | Delay | Loss | | configuration | configuration | configuration |
| QCI | Guarantee | Priority | budget | rate | Application | A | B (a) | B (b) |
| 4 | GBR | 3 | 50 ms | 1e−3 | Real-time | Option 1 | Option 3 | Option 1 or |
| | | | | | game | | | option 2 |

As shown in Table 4, options may be configured for each terminal. Alternatively, options may be configured for each service type. A plurality of service types may be provided, and for example, as shown in Table 5, a plurality of types intended for a service requiring delay may be defined.

TABLE 5

| | Queue | Queue | Queue |
|---|---|---|---|
| | configuration | configuration | configuration |
| Service type | A | B (a) | B (b) |
| Delay | Option 1 | Option 2 | Option 2 |
| (high request) | | | |
| Delay | Option 2 | Option 1 | Option 1 |
| (low request) | | | |
| Reliability | Option 1 | Option 2 | Option 2 |
| URLLC | Option 1 | Option 3 | Option 2 |
| (delay + reliability) | | | |

In addition, as shown in Table 6, a plurality of options may be configured according to the service type, and one of the plurality of options may be separately indicated.

TABLE 6

| | Queue | Queue | Queue |
|---|---|---|---|
| | configuration | configuration | configuration |
| Service type | A | B (a) | B (b) |
| Delay | Option 1 | Option 2 | Option 2 |
| (high request) | | | or option |
| | | | 3 |
| Delay | Option 2 | Option 1 | Option 1 |
| (low request) | | | |
| Reliability | Option 1 | Option 2 | Option 2 |
| | or option | or option | or option |
| | 3 | 3 | 3 |
| URLLC | Option 1 | Option 2 | Option 2 |
| (delay + reliability) | | or option | |
| | | 3 | |

For example, in the case of the configurations shown in Table 6, with respect to the queue configuration A, an indication as to which of option 1 and option 2 is to be used may be given only when reliability is configured as the service type.

According to the above-described embodiment, in the terminal 20, the APP or the NaaS client can execute the configuration related to the queue by indicating, to the OS or the network, the configuration.

In other words, the NaaS (Network as a Service) client can control QoS (Quality of Service)-provided communications.

(Apparatus Configuration)

Next, a functional configuration example of the network node 10 and the terminal 20 for performing the processes and operations described above will be described. The network node 10 and the terminal 20 include functions for implementing the embodiments described above. It should be noted, however, that each of the network node 10 and the terminal 20 may alternatively include only some of the functions in an embodiment.

<Network Node 10>

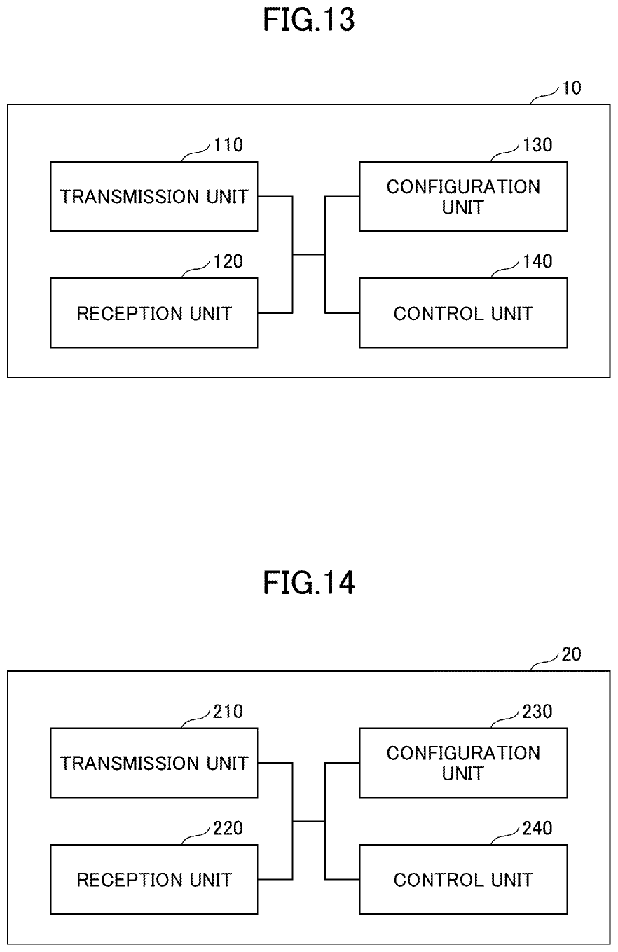

FIG. 13 is a diagram illustrating an example of a functional configuration of the network node 10. As illustrated in FIG. 13, the network node 10 includes a transmission unit 110, a reception unit 120, a configuration unit 130, and a control unit 140. The functional structure illustrated in FIG. 13 is merely an example. Functional divisions and names of functional units may be anything as long as operations according to an embodiment of the present invention can be performed. In addition, the network nodes 10 having multiple different functions in the system architecture may be composed of multiple network nodes 10 separated for each function.

The transmission unit 110 includes a function for generating a signal to be transmitted to the terminal 20 or to the network node 10 and transmitting the signal wirelessly. The reception unit 120 includes a function for receiving various signals transmitted from the terminal 20 and acquiring, for example, information of a higher layer from the received signals. Further, the transmission unit 110 has a function to transmit NR-PSS, NR-SSS, NR-PBCH, DL/UL control signals, DL reference signals, and the like to the terminal 20.

The configuration unit 130 stores preset configuration information and various configuration information items to be transmitted to the terminal 20 in a storage apparatus and reads the preset configuration information from the storage apparatus if necessary. The content of the configuration information is, for example, information related to QoS parameter management of the PDU session.

As described in the embodiment, the control unit 140 performs processing related to QoS control of the PDU session between the terminal 20 and the user plane. In addition, the control unit 140 may perform processing to realize the function of the application server. The functional units related to signal transmission in the control unit 140 may be included in the transmission unit 110, and the functional units related to signal reception in the control unit 140 may be included in the reception unit 120.

<Terminal 20>

FIG. 14 is a diagram illustrating an example of a functional configuration of the terminal 20. As shown in FIG. 14, the terminal 20 includes a transmission unit 210, a reception unit 220, a configuration unit 230, and a control unit 240. The functional structure illustrated in FIG. 14 is merely an example. Functional divisions and names of functional units may be anything as long as operations according to an embodiment of the present invention can be performed.

The transmission unit 210 generates a transmission signal from transmission data and transmits the transmission signal wirelessly. The reception unit 220 receives various signals wirelessly and obtains upper layer signals from the received physical layer signals. Further, the reception unit 220 has a function for receiving NR-PSS, NR-SSS, NR-PBCH, DL/UL/SL control signals, or reference signals transmitted from the network node 10. Further, for example, with respect to the D2D communications, the transmission unit 210 transmits, to another terminal 20, PSCCH (Physical Sidelink Control Channel), PSSCH (Physical Sidelink Shared Channel), PSDCH (Physical Sidelink Discovery Channel), PSBCH (Physical Sidelink Broadcast Channel), or the like, and the reception unit 220 receives, from the another terminal 20, PSCCH, PSSCH, PSDCH, or PSBCH, or the like. Furthermore, the transmission unit 210 and the reception unit 220 have a transmission/reception function of a wireless LAN or a wired LAN.

The configuration unit 230 stores various types of configuration information received from the network node 10 or the terminal 20 by the reception unit 220 in the storage device and reads the configuration information from the storage device as necessary. Further, the configuration unit 230 also stores pre-configured configuration information. The content of the configuration information is, for example, information related to QoS parameter management of a PDU session, information related to configuration of D2D communication, and the like.

As described in the embodiment, the control unit 240 performs processing related to QoS control of the PDU session between the terminal 20 and the user plane. In addition, the control unit 240 includes a scheduler that performs QoS control, based on APP-specific priorities. Further, the control unit 240 performs control related to D2D communication and QoS control in D2D communication. In addition, the control unit 240 may perform processing for realizing the function of the client application. The functional units related to signal transmission in the control unit 240 may be included in the transmission unit 210, and the functional units related to signal reception in the control unit 240 may be included in the reception unit 220.

(Hardware Structure)

In the above functional structure diagrams used for describing an embodiment of the present invention (FIG. 13 and FIG. 14), functional unit blocks are shown. The functional blocks (function units) are realized by a freely-selected combination of hardware and/or software. Further, realizing means of each functional block is not limited in particular. In other words, each functional block may be realized by a single apparatus in which multiple elements are coupled physically and/or logically, or may be realized by two or more apparatuses that are physically and/or logically separated and are physically and/or logically connected (e.g., wired and/or wireless). The functional blocks may be realized by combining the above-described one or more apparatuses with software.

Functions include, but are not limited to, judging, determining, calculating, processing, deriving, investigating, searching, checking, receiving, transmitting, outputting, accessing, resolving, selecting, establishing, comparing, assuming, expecting, and deeming; broadcasting, notifying, communicating, forwarding, configuring, reconfiguring, allocating, mapping, and assigning, etc. For example, a functional block (component) that functions to transmit is called a transmitting unit or a transmitter. In either case, as described above, the implementation method is not particularly limited.

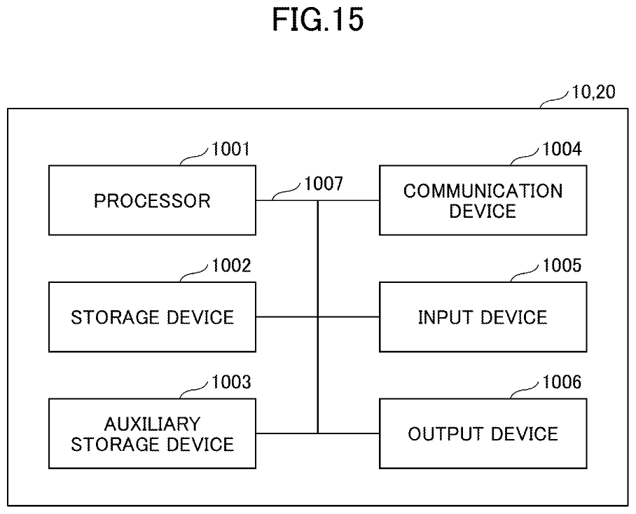

For example, the network node 10, terminal 20, etc., according to an embodiment of the present disclosure may function as a computer for processing the radio communication method of the present disclosure. FIG. 15 is a drawing illustrating an example of hardware structures of the network node 10 and the terminal 20 according to an embodiment of the present invention. Each of the above-described network node 10 and the terminal 20 may be physically a computer device including a processor 1001, a storage device 1002, an auxiliary storage device 1003, a communication device 1004, an input device 1005, an output device 1006, a bus 1007, etc.

It should be noted that, in the descriptions below, the term “apparatus” can be read as a circuit, a device, a unit, etc. The hardware structures of the network node 10 and the terminal 20 may include one or more of each of the devices illustrated in the figure, or may not include some devices.

Each function in the network node 10 and the terminal 20 is implemented by having the processor 1001 perform an operation by reading predetermined software (programs) onto hardware such as the processor 1001 and the storage device 1002, and by controlling communication by the communication device 1004 and controlling at least one of reading and writing of data in the storage device 1002 and the auxiliary storage device 1003.

The processor 1001 controls the entire computer by, for example, controlling the operating system. The processor 1001 may include a central processing unit (CPU) including an interface with a peripheral apparatus, a control apparatus, a calculation apparatus, a register, etc. For example, the above-described control unit 140, control unit 240, and the like, may be implemented by the processor 1001.

Further, the processor 1001 reads a program (program code), a software module, or data from the auxiliary storage device 1003, and/or the communication apparatus 1004 to the storage device 1002, and performs various processes according to the program, the software module, or the data. As the program, a program is used that causes the computer to perform at least a part of operations according to an embodiment of the present invention described above. For example, the control unit 140 of the network node 10 illustrated in FIG. 13 may be realized by control programs that are stored in the storage device 1002 and are executed by the processor 1001. Further, for example, the control unit 240 of the terminal 20 illustrated in FIG. 14 may be realized by control programs that are stored in the storage device 1002 and are executed by the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The storage device 1002 is a computer-readable recording medium, and may include at least one of a ROM (Read Only Memory), an EPROM (Erasable Programmable ROM), an EEPROM (Electrically Erasable Programmable ROM), a RAM (Random Access Memory), etc. The storage device 1002 may be referred to as a register, a cache, a main memory, etc. The storage device 1002 is capable of storing programs (program codes), software modules, or the like, that are executable for performing communication processes according to an embodiment of the present invention.

The auxiliary storage device 1003 is a computer-readable recording medium, and may include at least one of, for example, an optical disk such as a CD-ROM (Compact Disc ROM), a hard disk drive, a flexible disk, a magneto optical disk (e.g., compact disk, digital versatile disk, Blu-ray (registered trademark) disk), a smart card, a flash memory (e.g., card, stick, key drive), a floppy (registered trademark) disk, a magnetic strip, etc. The above recording medium may be a database including the storage device 1002 and/or the auxiliary storage device 1003, a server, or any other appropriate medium.

The communication apparatus 1004 is hardware (transmission and reception device) for communicating with computers via at least one of a wired network and a wireless network, and may be referred to as a network device, a network controller, a network card, a communication module, etc. The communication device 1004 may comprise a high frequency switch, duplexer, filter, frequency synthesizer, or the like, for example, to implement at least one of a frequency division duplex (FDD) and a time division duplex (TDD). For example, the transmitting/receiving antenna, the amplifier unit, the transmitting/receiving unit, the transmission line interface, and the like, may be implemented by the communication device 1004. The transmitting/receiving unit may be physically or logically divided into a transmitting unit and a receiving unit.

The input device 1005 is an input device that receives an external input (e.g., keyboard, mouse, microphone, switch, button, sensor). The output device 1006 is an output device that outputs something to the outside (e.g., display, speaker, LED lamp). It should be noted that the input device 1005 and the output device 1006 may be integrated into a single device (e.g., touch panel).

Further, the apparatuses including the processor 1001, the storage device 1002, etc., are connected to each other via the bus 1007 used for communicating information. The bus 1007 may include a single bus, or may include different buses between the apparatuses.

Further, each of the network node 10 and terminal 20 may include hardware such as a micro processor, a digital signal processor (DSP), an ASIC (Application Specific Integrated Circuit), a PLD (Programmable Logic Device), a FPGA (Field Programmable Gate Array), etc., and a part or all of each functional block may be realized by the hardware. For example, the processor 1001 may be implemented by at least one of the above hardware elements.

### Embodiment Summary

As described above, according to an embodiment of the present invention, a terminal is provided. The terminal includes a communication unit configured to perform communications, and a control unit configured to request a service with priority control related to the communications. The control unit is: an application that performs configuration related to a resource control unit for distributing a communication packet associated with a communication path; or a client of the service with priority control related to the communications.

According to the above configuration, in the terminal 20, the APP or the NaaS client can execute the configuration related to a resource control unit for distributing a communication packet by indicating, to the OS or the network, the configuration. In other words, the NaaS (Network as a Service) client can control QoS (Quality of Service)-provided communications.

The control unit may configure whether the resource control unit can be used exclusively. According to the configuration, the APP or the NaaS client can execute the configuration related to occupation of a resource control unit for distributing a communication packet.

The control unit may determine whether there is enough room in the resource control unit, and, based on the determination, may allow communication from another control unit in the resource control unit, may exclude another control unit from the resource control unit, or may perform no priority control. According to the configuration, the APP or the NaaS client can accept another APP into the resource control unit for distributing communication packets in a case where there is room in the resource control unit for distributing the communication packets. In addition, it is possible to use a resource control unit for distributing communication packets, the resource control unit having a possibility of satisfying a request by excluding the another APP.

When the communication unit starts communication, in a case where there is no resource control unit, which satisfies a request, for distributing a communication packet, the control unit may allow priority control at a quality lower than the request, may exclude another control unit from the resource control unit for distributing the communication packet, or may perform no priority control. According to the configuration, the APP or the NaaS client can use the resource control unit for distributing communication packets with a possibility of satisfying the request by excluding the another APP from the resource control unit for distributing the communication packets.

When the communication unit is performing communication, in a case where there is no resource control unit, which satisfies a request, for distributing a communication packet, the control unit may allow priority control at a quality lower than the request, may exclude another control unit from the resource control unit for distributing the communication packet, or may switch to a resource control unit for distributing another communication packet. According to the configuration, the APP or the NaaS client can use a resource control unit for distributing communication packets that may satisfy a request by excluding other APPs from the resource control unit for distributing communication packets.

In addition, according to an embodiment of the present invention, a communication method of a terminal is provided. The communication method includes performing communications, and requesting a service with priority control related to the communications. The requesting is performed by: an application that performs configuration related to a resource control unit for distributing a communication packet associated with a communication path; or a client of the service with priority control related to the communications.

According to the above configuration, in the terminal 20, the APP or the NaaS client can execute the configuration related to a resource control unit for distributing a communication packet by indicating, to the OS or the network, the configuration. In other words, the NaaS (Network as a Service) client can control QoS (Quality of Service)-provided communications.

### Supplement of Embodiment

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, each of the network node 10 and the terminal 20 has been described by using functional block diagrams. However, the apparatuses may be implemented by hardware, software, or a combination of hardware and software. The software executed by a processor included in the network node 10 according to an embodiment of the present invention and the software executed by a processor included in the terminal 20 according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

Further, information indication (transmission, notification) may be performed not only by methods described in an aspect/embodiment of the present specification but also a method other than those described in an aspect/embodiment of the present specification. For example, the information transmission may be performed by physical layer signaling (e.g., DCI (Downlink Control Information), UCI (Uplink Control Information)), upper layer signaling (e.g., RRC (Radio Resource Control) signaling, MAC (Medium Access Control) signaling, broadcast information (MIB (Master Information Block), SIB (System Information Block))), other signals, or combinations thereof. Further, RRC signaling may be referred to as an RRC message. The RRC signaling may be, for example, an RRC connection setup message, an RRC connection reconfiguration message, or the like.

Each aspect/embodiment described in the present disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and a next generation system enhanced therefrom. Further, multiple systems may also be applied in combination (e.g., at least one of LTE and LTE-A combined with 5G, etc.).

The order of processing steps, sequences, flowcharts or the like of an aspect/embodiment described in the present specification may be changed as long as there is no contradiction. For example, in a method described in the present specification, elements of various steps are presented in an exemplary order. The order is not limited to the presented specific order.

The particular operations, that are supposed to be performed by the network node 10 in the present specification, may be performed by an upper node in some cases. In a network including one or more network nodes including the network node 10, it is apparent that various operations performed for communicating with the terminal 20 may be performed by at least one of the network node 10 and another network node other than the network node 10 (for example, but not limited to, MME or S-GW). According to the above, a case is described in which there is another single network node other than the network node 10. However, the other network node may be a combination of multiple other network nodes (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL) and wireless technologies (infrared, microwave, etc.), at least one of these wired line technologies and wireless technologies is included within the definition of the transmission medium.

Information, a signal, or the like, described in the present specification may represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms “BS: Base Station”, “Radio Base Station”, “Base Station Apparatus”, “Fixed Station”, “NodeB”, “eNodeB (eNB)”, “gNodeB (gNB)”, “Access Point”, “Transmission Point”, “Reception Point”, “Transmission/Reception Point”, “Cell”, “Sector”, “Cell Group”, “Carrier”, “Component Carrier”, and the like, may be used interchangeably. The base station may be referred to as a macro-cell, a small cell, a femtocell, a picocell and the like.

The base station may accommodate (provide) one or more (e.g., three) cells. In the case where the base station accommodates a plurality of cells, the entire coverage area of the base station may be divided into a plurality of smaller areas, each smaller area may provide communication services by means of a base station subsystem (e.g., an indoor small base station or a remote Radio Head (RRH)). The term “cell” or “sector” refers to a part or all of the coverage area of at least one of the base station and base station subsystem that provides communication services at the coverage.

In the present disclosure, terms such as “mobile station (MS)”, “user terminal”, “user equipment (UE)”, “terminal”, and the like, may be used interchangeably.

There is a case in which the mobile station may be referred to, by a person skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station and the mobile station may be referred to as a transmission apparatus, reception apparatus, communication apparatus, or the like. The at least one of the base station and the mobile station may be a device mounted on the mobile station, the mobile station itself, or the like. The mobile station may be a vehicle (e.g., a car, an airplane, etc.), an unmanned mobile body (e.g., a drone, an automated vehicle, etc.), or a robot (manned or unmanned). At least one of the base station and the mobile station may include an apparatus that does not necessarily move during communication operations. For example, at least one of the base station and the mobile station may be an IoT (Internet of Things) device such as a sensor.

Further, the base station in the present disclosure may be read as the user terminal. For example, each aspect/embodiment of the present disclosure may be applied to a configuration in which communications between the base station and the user terminal are replaced by communications between multiple terminals 20 (e.g., may be referred to as D2D (Device-to-Device), V2X (Vehicle-to-Everything), etc.). In this case, a function of the network node 10 described above may be provided by the terminal 20. Further, the phrases “up” and “down” may also be replaced by the phrases corresponding to terminal-to-terminal communication (e.g., “side”). For example, an uplink channel, an downlink channel, or the like, may be read as a sidelink channel.

Further, the user terminal in the present disclosure may be read as the base station. In this case, the function of the user terminal described above may be provided by the base station.

The term “determining” used in the present specification may include various actions or operations. The “determining” may include, for example, a case in which “judging”, “calculating”, “computing”, “processing”, “deriving”, “investigating”, “looking up, search, inquiry” (e.g., looking up a table, database, or other data structures), or “ascertaining” is deemed as “determining”. Further, the “determining” may include a case in which “receiving” (e.g., receiving information), “transmitting” (e.g., transmitting information), “inputting”, “outputting”, or “accessing” (e.g., accessing data in a memory) is deemed as “determining”. Further, the “determining” may include a case in which “resolving”, “selecting”, “choosing”, “establishing”, “comparing”, or the like is deemed as “determining”. In other words, the “determining” may include a case in which a certain action or operation is deemed as “determining”. Further, “decision” may be read as “assuming,” “expecting,” or “considering,” etc.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS or may be referred to as a pilot, depending on the applied standards.

The description “based on” used in the present specification does not mean “based on only” unless otherwise specifically noted. In other words, the phrase “based on” means both “based on only” and “based on at least”.

Any reference to an element using terms such as “first” or “second” as used in the present disclosure does not generally limit the amount or the order of those elements. These terms may be used in the present disclosure as a convenient way to distinguish between two or more elements. Therefore, references to the first and second elements do not imply that only two elements may be employed or that the first element must in some way precede the second element.

“Means” included in the configuration of each of the above apparatuses may be replaced by “parts,” “circuits,” “devices,” etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

An aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

Note that NaaS is an example of a service involving priority control related to communication. The APP or NaaS client is an example of the control unit.

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

The present international patent application is based on and claims priority to Japanese patent application No. 2020-091752 filed on May 26, 2020, the entire contents of which are hereby incorporated herein by reference.

### DESCRIPTION OF THE REFERENCE NUMERALS

10 Network node
110 Transmission unit
120 Reception unit
130 Configuration unit
140 Control unit
20 Terminal
210 Transmission unit
220 Reception unit
230 Configuration unit
240 Control unit
1001 Processor
1002 Storage device
1003 Auxiliary storage device
1004 Communication device
1005 Input device
1006 Output device

What is claimed is:

1. A terminal comprising:
a communication unit configured to perform communication; and
a control unit configured to request a service with priority control related to the communication, wherein
the control unit is: an application that performs configuration related to a resource control unit for distributing communication packets associated with a communication path; or a client of the service with priority control related to the communication.

2. The terminal as claimed in claim 1, wherein the control unit configures whether the resource control unit is usable exclusively.

3. The terminal as claimed in claim 1, wherein
the control unit determines whether there is enough room in the resource control unit, and,
based on the determination,
allows communication by another control unit in the resource control unit,
excludes the another control unit from the resource control unit, or
performs no priority control.

4. The terminal as claimed in claim 1, wherein, when the communication unit starts the communication, in a case where there is no resource control unit, which satisfies a request, for distributing communication packets,
the control unit
allows priority control at a quality lower than the request,
excludes another control unit from the resource control unit for distributing the communication packets, or
performs no priority control.

5. The terminal as claimed in claim 1, wherein, when the communication unit is performing the communication, in a case where there is no resource control unit, which satisfies a request, for distributing communication packets,
the control unit
allows priority control at a quality lower than the request,
excludes another control unit from the resource control unit for distributing the communication packets, or
switches to a resource control unit for distributing other communication packets.

6. A communication method performed by a terminal, the communication method comprising:
performing communication; and
requesting a service with priority control related to the communication, wherein
the requesting is performed by: an application that performs configuration related to a resource control unit for distributing communication packets associated with a communication path; or a client of the service with priority control related to the communication.
